(19) United States
(12) Patent Application Publication
(10) Pub. No.: US 2013/0143023 A1
(43) Pub. Date: Jun. 6, 2013

(54) Coating Compositions For Producing Permanently Flexible Coatings

(71) Applicants: Hardy Herold, Burgthausen (DE); Roland Schickor, Simbach (DE)

(72) Inventors: Hardy Herold, Burgthausen (DE); Roland Schickor, Simbach (DE)

(73) Assignee: Waker Chemie AG, Munich (DE)

(21) Appl. No.: 13/816,669

(22) PCT Filed: Aug. 2, 2011
(86) PCT No.: PCT/EP2011/063258

§ 371 Date: Feb. 12, 2013

(30) Foreign Application Priority Data
Aug. 13, 2010 (DE) 102010039319.3

(51) Int. Cl. C04B 2/02

(52) U.S. Cl. CPC C04B 2/02
USPC 428/220; 524/5

(57) ABSTRACT

Provided by the invention are coating compositions based on one or more mineral binders, one or more polymers, one or more fillers and optionally one or more additives, characterized in that 2% to 30% by weight of lime is present, based on the dry weight of the coating compositions, as a mineral binder in the coating composition.

### CROSS REFERENCE TO RELATED APPLICATIONS

This application is the national phase filing of international patent application No. PCT/EP2011/063258, filed 2 Aug. 2011, and claims priority of German application number 10 2010 039 319.3, filed 13 Aug. 2010, the entireties of which applications are incorporated herein by reference.

### FIELD OF THE INVENTION

The invention relates to coating compositions based on mineral binders, polymers and fillers and also to their use for producing permanently flexible coatings.

### BACKGROUND OF THE INVENTION

The use is known in the construction sector of coating compositions based on mineral binders, polymers and fillers for producing flexible coatings. Coating compositions of this kind are used, for example, as grouts, as described in U.S. Pat. No. 6,166,113 or DE-A 19620817. U.S. Pat. No. 4,710,526 discloses mortar compositions based on cement and cationic polymers for producing flexible coatings having good adhesive properties. KR 100913255 describes cementitious polymer-modified mortar compositions for producing construction products having enhanced mechanical and chemical resistance. GB 1236263 discloses compositions based on mineral binders, fillers and polymers and also additives, such as hydroxy-carboxylic acids. U.S. Pat. No. 5,543,188 recommends membranes comprising a polymer layer that are impregnated with cementitious dry mixes. US 2008/0060299 and US 2006/0054059 describe flexible membranes based on plastics mats equipped with flexible, cementitious, polymer-modified coatings.

The existing coating compositions, however, result in coatings which over time become slowly brittle and hence are not permanently flexible. The embrittlement is manifested in a fall-off in the elongation at break or crack-bridging ability of the coatings. The crack-bridging properties of the coatings are essential, however, in order to protect the coated substrates. Cracks may be formed in the substrates, such as constructions, as a consequence of earthquakes or of ageing processes, or of other mechanical impositions. The flexible coatings are intended to bridge cracks of this kind and thereby to prevent water penetration into the substrates. If, however, the coatings have now become brittle and are therefore no longer flexible, the coatings tend to crack themselves over the course of time, or develop other kinds of damage, thereby allowing water to penetrate through the coatings into the underlying substrates, with the consequence of corresponding water damage. As a result of the embrittlement, then, the coatings no longer fulfil their purpose, or do so inadequately. Embrittlement occurs to an increased extent when the coatings are subject to damp or even to wet conditions. With permanently flexible coatings, i.e., coatings which have a durable flexibility, such damage ought to be prevented.

Against this background, the object was to provide coating compositions for producing permanently flexible coatings that are less susceptible to embrittlement, not least under damp or wet conditions, and, consequently, are durably flexible.

### SUMMARY OF THE INVENTION

The invention first provides coating compositions based on one or more mineral binders, one or more polymers, one or more fillers and optionally one or more additives, characterized in that 2% to 30% by weight of lime is present, based on the dry weight of the coating compositions, as a mineral binder in the coating composition.

### DETAILED DESCRIPTION OF THE INVENTION

Polymers used are generally addition polymers of one or more ethylenically unsaturated monomers. Preferred ethylenically unsaturated monomers are selected from the group encompassing vinyl esters, (meth)acrylic esters, vinylaromatics, olefins, 1,3-dienes and vinyl halides, and optionally further monomers copolymerizable therewith.

Suitable vinyl esters are, for example, those of carboxylic acids having 1 to 15 C atoms. Preferred are vinyl acetate, vinyl propionate, vinyl butyrate, vinyl 2-ethylhexanoate, vinyl laurate, 1-methylvinyl acetate, vinyl pivalate and vinyl esters of α-branched monocarboxylic acids having 9 to 11 C atoms, for example VeoVa9® or VeoVa10® (trade names of the company Resolution). Particularly preferred is vinyl acetate.

Suitable monomers from the group of acrylic esters or methacrylic esters are, for example, esters of unbranched or branched alcohols having 1 to 15 C atoms. Preferred methacrylic esters or acrylic esters are methyl acrylate, methyl methacrylate, ethyl acrylate, ethyl methacrylate, propyl acrylate, propyl methacrylate, n-butyl acrylate, n-butyl methacrylate, tert-butyl acrylate, tert-butyl methacrylate, 2-ethylhexyl acrylate. Particularly preferred are methyl acrylate, methyl methacrylate, n-butyl acrylate, tert-butyl acrylate and 2-ethylhexyl acrylate.

Preferred vinylaromatics are styrene, methylstyrene and vinyltoluene. Preferred vinyl halide is vinyl chloride. The preferred olefins are ethylene, propylene, and the preferred dienes are 1,3-butadiene and isoprene.

Optionally it is possible for 0% to 10% by weight, based on the total weight of the monomer mixture, of auxiliary monomers to be copolymerized. It is preferred to use 0.1% to 5% by weight of auxiliary monomers. Examples of auxiliary monomers are ethylenically unsaturated monocarboxylic and dicarboxylic acids, preferably acrylic acid, methacrylic acid, fumaric acid and maleic acid; ethylenically unsaturated carboxamides and carbonitriles, preferably acrylamide and acrylonitrile; monoesters and diesters of fumaric acid and maleic acid, such as the diethyl and diisopropyl esters, and also maleic anhydride; ethylenically unsaturated sulphonic acids and/or their salts, preferably vinylsulphonic acid, 2-acrylamido-2-methylpropanesulphonic acid. Further examples are precrosslinking comonomers such as polyethylenically unsaturated comonomers, examples being diallyl phthalate, divinyl adipate, diallyl maleate, allyl methacrylate or triallyl cyanurate, or postcrosslinking comonomers, examples being acrylamido glycolic acid (AGA), methylacrylamido glycolic acid methyl ester (MAGME), N-methylolacrylamide (NMA), N-methylolmethacrylamide, N-methylol allylcarbamate, alkyl ethers such as the isobutoxy ether or esters of N-methylolacrylamide, of N-methylolmethacrylamide and of N-methylol allylcarbamate. Also suitable are epoxide-functional comonomers such as glycidyl methacrylate and glycidyl acrylate. Further examples are silicon-functional comonomers, such as acryloyloxypropyltri(alkoxy)- and methacryloyloxypropyltri(alkoxy)silanes, vinyltrialkoxysilanes and vinylmethyldialkoxysilanes, where alkoxy groups that may be present include, for example, ethoxy radicals and ethoxypropylene glycol ether radicals. Mention may also be made of monomers having hydroxyl groups or CO groups, examples being hydroxyalkyl acrylates and methacrylates such as hydroxyethyl, hydroxypropyl or hydroxybutyl acrylate or methacrylate, and also compounds such as diacetoneacrylamide and acetylacetoxyethyl acrylate or methacrylate.

Preference is given to one or more polymers selected from the group encompassing vinyl ester homopolymers, vinyl ester copolymers comprising one or more monomer units from the group encompassing vinyl esters, olefins, vinyl aromatics, vinyl halides, acrylic esters, methacrylic esters, fumaric and/or maleic monoesters or diesters; (meth)acrylic ester homopolymers, (meth)acrylic ester copolymers comprising one or more monomer units from the group encompassing methacrylic esters, acrylic esters, olefins, vinyl aromatics, vinyl halides, fumaric and/or maleic monoesters or diesters; homopolymers or copolymers of dienes such as butadiene or isoprene, and also of olefins such as ethene or propene, it being possible for the dienes to be copolymerized with, for example, styrene, (meth)acrylic esters or the esters of fumaric or maleic acid; homopolymers or copolymers of vinylaromatics, such as styrene, methylstyrene, vinyltoluene; homopolymers or copolymers of vinylhalogen compounds such as vinyl chloride, it being possible for the polymers also to contain auxiliary monomers.

Particular preference is given to copolymers of one or more vinyl esters with 1% to 50% by weight of ethylene; copolymers of vinyl acetate with 1% to 50% by weight of ethylene and 1% to 50% by weight of one or more further comonomers from the group of vinyl esters having 1 to 12 C atoms in the carboxylic acid radical, such as vinyl propionate, vinyl laurate, vinyl esters of alpha-branched carboxylic acids having 9 to 13 C atoms, such as VeoVa9, VeoVa10, VeoVa11; copolymers of one or more vinyl esters, 1% to 50% by weight of ethylene and preferably 1% to 60% by weight of (meth)acrylic esters of unbranched or branched alcohols having 1 to 15 C atoms, more particularly n-butyl acrylate or 2-ethylhexyl acrylate; and copolymers with 30% to 75% by weight of vinyl acetate, 1% to 30% by weight of vinyl laurate or vinyl esters of an alpha-branched carboxylic acid having 9 to 11 C atoms, and also 1% to 30% by weight of (meth)acrylic esters of unbranched or branched alcohols having 1 to 15 C atoms, more particularly n-butyl acrylate or 2-ethylhexyl acrylate, which also contain 1% to 40% by weight of ethylene; copolymers with one or more vinyl esters, 1% to 50% by weight of ethylene and 1% to 60% by weight of vinyl chloride; the polymers may further comprise the stated auxiliary monomers in the stated amounts, and the amounts in % by weight add up to 100% by weight in each case.

Particular preference is also given to (meth)acrylic ester polymers, such as copolymers of n-butyl acrylate or 2-ethylhexyl acrylate or copolymers of methyl methacrylate with n-butyl acrylate and/or 2-ethylhexyl acrylate; styrene-acrylic ester copolymers with one or more monomers from the group of methyl acrylate, ethyl acrylate, propyl acrylate, n-butyl acrylate, 2-ethylhexyl acrylate; vinyl acetate-acrylic ester copolymers with one or more monomers from the group of methyl acrylate, ethyl acrylate, propyl acrylate, n-butyl acrylate, 2-ethylhexyl acrylate and optionally ethylene; styrene-1,3-butadiene copolymers; the polymers may further comprise auxiliary monomers in the stated amounts, and the amounts in % by weight add up to 100% by weight in each case.

Examples of particularly preferred comonomers for vinyl chloride copolymers are α-olefins, such as ethylene or propylene, and/or vinyl esters, such as vinyl acetate, and/or acrylic esters or methacrylic esters of alcohols having 1 to 15 C atoms, such as methyl acrylate, methyl methacrylate, ethyl acrylate, ethyl methacrylate, propyl acrylate, propyl methacrylate, n-butyl acrylate, tert-butyl acrylate, n-butyl methacrylate, tert-butyl methacrylate, 2-ethylhexyl acrylate and/or fumaric and/or maleic monoesters or diesters such as the dimethyl, methyl tert-butyl, di-n-butyl, di-tert-butyl and diethyl esters of maleic acid or fumaric acid, respectively.

Most preferred are copolymers with vinyl acetate and 5% to 50% by weight of ethylene; or copolymers with vinyl acetate, 1% to 50% by weight of ethylene and 1% to 50% by weight of a vinyl ester of α-branched monocarboxylic acids having 9 to 11 C atoms; or copolymers with 30% to 75% by weight of vinyl acetate, 1% to 30% by weight of vinyl laurate or vinyl esters of an alpha-branched carboxylic acid having 9 to 11 C atoms, and also 1% to 30% by weight of (meth)acrylic esters of unbranched or branched alcohols having 1 to 15 C atoms which further contain 1% to 40% by weight of ethylene; or copolymers with vinyl acetate, 5% to 50% by weight of ethylene and 1% to 60% by weight of vinyl chloride.

The most preferred copolymers are also vinyl chloride-ethylene copolymers containing 60% to 98% by weight of vinyl chloride units and 1% to 40% by weight of ethylene units, the amounts in % by weight being based on the total weight of the copolymer and adding up to 100% by weight in each case. Vinyl chloride-ethylene copolymers of this kind are known from EP 0 149 098 A2.

The monomer selection, and the selection of the weight fractions of the comonomers, are made such as to result in a glass transition temperature, Tg, of −50° C. to +30° C., preferably −40° C. to +10° C., more preferably −30° C. to 0° C. The glass transition temperature Tg of the polymers can be determined in a known way by means of Differential Scanning calorimetry (DSC). The Tg may also be calculated approximately in advance by means of the Fox equation. According to Fox T. G., Bull. Am. Physics Soc. 1, 3, page 123 (1956), the following holds: 1/Tg=x1/Tg1+x2/Tg2+ . . . +xn/Tgn, where xn is the mass fraction (% by weight/100) of the monomer n, and Tgn is the glass transition temperature, in kelvins, of the homopolymer of the monomer n. Tg values for homopolymers are listed in Polymer Handbook 2nd Edition, J. Wiley & Sons, New York (1975).

The polymers are prepared generally in aqueous medium and preferably by the emulsion or suspension polymerization process—as described in DE-A 102008043988, for example. The polymers in these cases are obtained in the form of aqueous dispersions. During the polymerization it is possible to use the common protective colloids and/or emulsifiers, as described in DE-A 102008043988. The protective colloids may be anionic or preferably cationic or nonionic. Preference is also given to combinations of cationic and nonionic protective colloids. Preferred nonionic protective colloids are polyvinyl alcohols. Preferred cationic protective colloids are polymers which carry one or more cationic charges, as described in E. W. Flick, Water Soluble Resins—an Industrial Guide, Noyes Publications, Park Ridge, N.J., 1991, for example. Preferred as protective colloids are partially hydrolysed or fully hydrolysed polyvinyl alcohols having a degree of hydrolysis of 80 to 100 mol %, more particularly partially hydrolysed polyvinyl alcohols having a degree of hydrolysis of 80 to 94 mol % and a Hoppler viscosity, in 4% strength aqueous solution, of 1 to 30 mPas (Höppler method at 20° C., DIN 53015). The stated protective colloids are obtainable by means of processes known to the skilled person, and are added generally in an amount totalling 1% to 20% by weight, based on the total weight of the monomers, in the polymerization.

The polymers in the form of aqueous dispersions can be converted, as described in DE-A 102008043988, into corresponding, water-redispersible powders. In this case, in general, a drying aid is used, in a total amount of 3% to 30% by weight, preferably 5% to 20% by weight, based on the polymeric constituents of the dispersion. Preferred drying aids are the aforementioned polyvinyl alcohols.

Essential to the invention is the use of lime as a mineral binder. As lime it is possible to use, for example, lime hydrate, white lime hydrate, calcium oxide (unslaked lime) or high-hydraulic lime.

Suitable mineral binders besides lime are, for example, cement, more particularly portland cement, aluminate cement, especially calcium sulphoaluminate cement, trass cement, slag cement, magnesia cement, phosphate cement, and blast furnace cement, and also mixed cements, filler cements, flyash, microsilica, slag sand, or gypsum. Besides lime, therefore, there may be one or more other mineral binders present in the coating compositions. Further mineral binders present are preferably one or more cementitious binders selected from the group encompassing cement, more particularly portland cement, aluminate cement, especially calcium sulphoaluminate cement, trass cement, slag cement, magnesia cement, phosphate cement, and blast furnace cement, and also mixed cements, filler cements.

Examples of suitable fillers are quartz sand, finely ground quartz, finely ground limestone, calcium carbonate, dolomite, clay, chalk, white lime hydrate, talc or mica, granulated rubber or hard fillers, such as aluminium silicates, corundum, basalt, carbides, such as silicon carbide or titanium carbide, or fillers which give a pozzolanic reaction, such as flyash, metakaolin, microsilica. As fillers, preference is given to quartz sand, finely ground quartz, finely ground limestone, calcium carbonate, calcium magnesium carbonate (dolomite) or chalk. The fillers preferably comprise no gravel. Gravel generally has average particle diameters of ≧4 mm.

It is also possible to use any desired mixtures of the stated fillers. Preferred mixtures comprise one or more silicatic fillers, such as sand, and one or more carbonatic fillers selected from the group encompassing calcium carbonate, chalk, dolomite and limestone. Preferred mixtures comprise one or more silicatic fillers and one or more carbonatic fillers in a ratio from 1:1 to 4:1.

The fillers preferably have average particle diameters of 0.01 to 4 mm, more preferably 0.02 to 3 mm and most preferably 0.03 to 2 mm.

Preferably at least 50% to 100% by weight of the fillers have a diameter of 0.001 to 0.5 mm; more preferably at least 70% to 100% by weight of the fillers have a diameter of 0.01 to 0.3 mm; these figures are based in each case on the dry weight of the total fillers employed. As a consequence of the filler particle diameters according to the invention, the coating compositions undergo reduced shrinkage in the course of the production of the permanently flexible coatings, and this counteracts cracking within the permanently flexible coatings and is conducive to crack bridging.

Typical formulas for the coating compositions comprise preferably 10% to 60% by weight, more preferably 20% to 55% by weight and most preferably 30% to 50% by weight of polymers; preferably 2% to 30% by weight, more preferably 2% to 20% by weight and most preferably 3% to 15% by weight of lime; preferably 10% to 80% by weight, more preferably 20% to 70% by weight and most preferably 40% to 60% by weight of fillers; the amounts in % by weight here relate to the dry weight of the coating compositions and add up in total to 100% by weight.

The mineral binders preferably comprise 30% to 100% by weight, more preferably 50% to 100% by weight and most preferably 80% to 100% by weight of lime, based on the dry weight of the mineral binders (i.e. including lime).

The mineral binders preferably comprise 0% to 70% by weight, more preferably 0% to 50% by weight and most preferably 0% to 20% by weight of cementitious binders, based on the dry weight of the mineral binders (i.e. including lime).

In an alternative, preferred embodiment, the coating compositions comprise no cementitious binders, flyash, microsilica, slag sand or gypsum. With particular preference the coating compositions comprise no cementitious binders.

The coating compositions are preferably dry mixes. The coating compositions are generally converted into aqueous coating compositions directly prior to their application, by addition of water.

Aqueous coating compositions comprise preferably 15 to 50% by weight and more preferably 20 to 40% by weight of water, based on the dry weight of the coating compositions.

The performance properties of the coating compositions may be improved by means of additives or adjuvants. Examples of suitable additives include pigments, especially inorganic pigments, such as oxide pigments, oxide hydroxide pigments, sulphide pigments, sulphoselenide pigments, carbonate pigments, chromate pigments, mixed-phase chromate-molybdate pigments or silicate pigments. Preferred pigments in this context are pigments comprising titanium, iron, chromium or cadmium. The most preferred pigments are titanium dioxide.

Examples of suitable additives are highly disperse silicas, also known under the abbreviation HDK, such as, for example, fumed silica or precipitated silica. Highly disperse silicas are present in the coating compositions preferably at 0.1% to 3% and more preferably at 0.1% to 1% by weight, based on the dry weight of the respective coating compositions. By using highly disperse silicas it is possible to prevent further the penetration of water into the flexible coatings. Furthermore, the highly disperse silicas also have advantageous consequences for the processing properties, since corresponding aqueous coating compositions are less tacky and dry out more quickly in the course of the setting of the mineral binders.

A preferred additive also are phyllosilicates. Coating compositions comprising phyllosilicates lead to flexible coatings having a higher degree of imperviousness to water. Phyllosilicates are present preferably at 0% to 3% by weight and more preferably at 0.1% to 2% by weight, based on the dry weight of the coating compositions.

Preferred additives are also fibres. Examples of suitable fibres are Kevlar, viscose fibres, polyamide fibres, polyester fibres, polyacrylonitrile fibres, Dralon fibres, polyethylene fibres, polypropylene fibres, polyvinyl alcohol fibres, aramid fibres or carbon fibres. Fibres are present preferably at 0% to 3% by weight and more preferably at 0.1% to 2% by weight, based on the dry weight of the coating compositions. The use of fibres results in coatings having more strongly crack-bridging properties.

Typical adjuvants for the coating compositions are thickeners, examples being polysaccharides such as cellulose ethers and modified cellulose ethers, starch ethers, guar gum, xanthan gum, polycarboxylic acids such as polyacrylic acid and the partial esters thereof, and also polyvinyl alcohols, which optionally may have been acetylized or hydrophobically modified, and casein and associative thickeners. Customary adjuvants are also crosslinkers such as metal oxides or semimetal oxides, more particularly boric acid or polyborates, or dialdehydes, such as glutardialdehyde; customary adjuvants are also setting accelerators, examples being alkali metal salts or alkaline earth metal salts of inorganic or organic acids. Mention may also be made, furthermore, of the following: preservatives, film-forming assistants, dispersants, foam stabilizers, defoamers, plasticizers, flow control agents and flame retardants (e.g. aluminium hydroxide).

In general, the fraction of adjuvants as a proportion of the coating compositions overall is 0% to 20% by weight, preferably 0.1% to 15% by weight and more preferably 0.1% to 10% by weight, based in each case on the dry weight of the coating compositions.

The preparation of the coating compositions based on mineral binders, polymers, fillers and optionally additives is not tied to any particular procedure or mixing apparatus. The coating compositions are obtainable by mixing of the individual ingredients of the formula in conventional powder mixing apparatus, as for example by means of mortar mixers, concrete mixers or plaster machines or stirrers, and homogenization. The individual ingredients are used generally in dry form at the mixing stage.

The polymers can be used in the form of aqueous dispersions or, preferably, in the form of water-redispersible powders.

The flexible coating compositions may be provided in, for example, the form of one-component systems or two-component systems. One-component systems comprise all of the ingredients of the coating compositions. With one-component systems, the formulations are generally dry formulations. One-component systems are preferably produced by premixing polymers, additives and optionally adjuvants and admixing mineral binders and fillers at a later point in time. To produce the aqueous coating compositions, the water may be admixed at any later point in time, generally shortly prior to application of the coating compositions.

Two-component systems comprise a first component and a second component. The first component comprises all of the ingredients of the flexible coating compositions apart from polymers. The first component is generally a dry formulation. The second component comprises the polymers, preferably in the form of aqueous dispersions. For preparing the coating compositions, which may be aqueous, the first component and the second component are mixed, where appropriate with addition of water.

The coating compositions are suitable, for example, for use as grouts, construction adhesives, jointing mortars, repair mortars or renders.

The invention further provides for the use of the coating compositions based on one or more mineral binders, one or more polymers, one or more fillers and optionally one or more additives for producing permanently flexible coatings, characterized in that 2% to 30% by weight of lime is present, based on the dry weight of the coating compositions, as a mineral binder in the coating composition.

The permanently flexible coatings have coat thicknesses of preferably 1 to 10 mm, more preferably 2 to 5 mm and most preferably 2 to 3 mm.

The coating compositions may be applied to any substrates. The substrates may for instance be organic or inorganic, natural or synthetic. Examples of natural substrates are floors, rock, stone or scree. Examples of synthetic substrates are primarily substrates from the construction sector, such as substrates based on compositions comprising mineral binders, more particularly concrete or screed, but also timber materials, plastics materials, more particularly polyurethane foam boards, or metals, more particularly aluminium. Substrates from the construction sector are preferred.

The aqueous coating compositions may be applied by manual methods or mechanical methods. In the case of manual methods, the aqueous coating compositions are applied to the substrate with the aid of coarse brushes, fine brushes, rollers, knives, trowels, paddles or shovels. In the case of mechanical methods, the aqueous coating compositions are applied to the substrate by means of spraying machines, plaster machines or robots. Two or more coats of coating compositions may be applied one above another. It is preferred to apply only one coat of the coating compositions to a substrate. Following the application of coating compositions to the substrates, the surface of the applied coat may be smoothed, using smoothing discs or paddle smoothers, for example.

The coating compositions are applied typically at ambient temperatures, i.e. in general at temperatures from 0 to 50° C., more particularly from 5 to 35° C.

The substrates may be primed before the coating compositions are applied. Examples of suitable primers include aqueous dispersions of the abovementioned polymers, preferably with solids contents of 10% to 50%.

Finally, further coats may be applied to the permanently flexible coatings of the invention, such as, for example, paint coatings or claddings or coverings of tiles or slabs for the interior or exterior. Also contemplated are coatings of floor-filling compounds or screeds. In many cases, however, the coatings of the invention constitute the topmost or finishing coat.

The coating compositions are used preferably for producing permanently flexible coatings for mines or tunnels, more preferably for producing mines.

The coating compositions of the invention result, surprisingly, in permanently flexible coatings which, as compared with conventional, cementitious coatings, exhibit improved elongation at break behaviour and hence an improved crack-bridging capacity, countering embrittlement of the coatings. These statements are true, surprisingly, in fact to an increased extent for coatings which are subject to wet or damp conditions. Under such conditions there is in fact an increase in the crack-bridging properties of the coatings of the invention, in contrast to corresponding cementitious coatings. Accordingly the coatings obtainable in accordance with the invention are especially suitable for protecting constructions, for example, against penetrating water.

The examples which follow serve for detailed elucidation of the invention and should in no way be understood to constitute any restriction.

### Inventive Example 1 (IEx. 1)

The coating composition was prepared by introducing the individual ingredients of the formula indicated below, in the following order, with mixing, into a Toni mixer (commercial laboratory mixer): first the lime hydrate, then the fillers, the dispersion powder and lastly the remaining additives. This was followed by homogeneous mixing on setting 1 for 15 minutes. The aqueous coating composition was produced from the resultant dry mix in the manner indicated in EN 196-1, with the stated amount of water.

The aqueous coating composition was applied to Teflon formwork components (base area: 30×15 cm) in a wet film thickness of 2 mm. The wet films were smoothed using a trowel. After storage for 24 hours under standard conditions in accordance with DIN 50014, the films had cured and, following removal of the Teflon formwork components, were subjected to the following storage conditions:
one film was stored for 28 days under standard conditions (23° C./50% relative humidity) (dry storage);
another, identical film, following the aforementioned dry storage, was stored for a further 38 days in mains water at 23° C. and thereafter for 28 days under standard conditions (23° C./50% relative humidity) (wet storage).
   Formula of the coating composition:
   10% by weight lime hydrate,
   40% by weight dispersion powder Vinnapas® 4040 N (vinyl acetate-ethylene copolymer, stabilized with polyvinyl alcohol and a cationic protective colloid),
   0.5% by weight highly disperse silica (Wacker HDK H 15),
   0.5% by weight defoamer (Agitan P 800),
   1.5% by weight inorganic phyllosilicate thickener (Optibent MF),
   13.4% by weight Omyacarb 20 BG (carbonatic filler) and
   34.1% by weight sand (0.063 to 0.3 mm; silicatic filler).

### Comparative Example 2 (CEx. 2)

In analogy to Inventive Example 1, with the difference that the formula used for preparing the coating composition was as follows:

10% by weight portland cement CEM I 42.5 N,
30% by weight dispersion powder Vinnapas® 4040 N,
0.5% by weight highly disperse silica (Wacker HDK H 15),
0.5% by weight defoamer (Agitan P 800),
1.5% by weight inorganic phyllosilicate thickener (Optibent MF),
17.8% by weight Omyacarb 20 BG (carbonatic filler) and
39.7% by weight sand (0.063 to 0.3 mm; silicatic filler).

The formula therefore contains a portland cement in the place of the lime hydrate of Example 1.

### Performance Testing

In accordance with ISO 527-3 (8/1995), 2 type 1 B standard rods were punched from each of the films obtained after dry storage and wet storage, from Inventive Example 1 and from Comparative Example 2, respectively.

The tensile strength and elongation at break of the standard rods were then determined by means of a tensile test in accordance with ISO 527-3 (8/1995). The standard rods were stretched to failure at a tensioning speed of 50 mm/min. The results of the testing are set out in Table 1.

TABLE
Testing of the coatings:

| | Tensile strength [N/mm²] | | Elongation at break [%] | |
|---|---|---|---|---|
| | Dry storage | Wet storage | Dry storage | Wet storage |
| IEx. 1 | 1.4 | 2.2 | 45 | 61 |
| CEx. 2 | 1.7 | 2.5 | 29 | 8 |

For inventive Example 1, surprisingly, the elongation at break values after wet storage were higher than after dry storage (Table 1). This finding is in contrast with the behaviour known for cementitious coatings (Comparative Example 2). Moreover, both in dry storage and in wet storage, coatings of Inventive Example 1 exhibit better tensile strengths than cementitious coatings (Comparative Example 2). Since the tensile strength correlates with the crack-bridging property of coatings, the coatings of the invention are particularly flexible. This is especially true of coatings exposed to wet conditions.

1. A coating composition based on one or more mineral binders, one or more polymers, one or more fillers and optionally one or more additives, wherein 2% to 30% by weight of lime, based on the dry weight of the coating composition, as a mineral binder and 0% to 3% by weight of fibres are present, based on the dry weight of the coating composition, in the coating composition,
wherein 80% to 100% by weight of the mineral binders are lime, based on the dry weight of the mineral binders, and
the one or more polymers are selected from the group consisting of copolymers of one or more vinyl esters with 1% to 50% by weight of ethylene;
copolymers of vinyl acetate with 1% to 50% by weight of ethylene and 1% to 50% by weight of one or more further comonomers from the group consisting of vinyl esters having 1 to 12 C atoms in the carboxylic acid radical;
copolymers of one or more vinyl esters and 1% to 50% by weight of ethylene and optionally 1% to 60% by weight of (meth)acrylic esters of unbranched or branched alcohols having 1 to 15 C atoms; and
copolymers with 30% to 75% by weight of vinyl acetate, 1% to 30% by weight of vinyl laurate or vinyl ester of an alpha-branched carboxylic acid having 9 to 11 C atoms, and also 1% to 30% by weight of (meth)acrylic esters of unbranched or branched alcohols having 1 to 15 C atoms, further comprising 1% to 40% by weight of ethylene; and
copolymers with one or more vinyl esters, 1% to 50% by weight of ethylene and 1% to 60% by weight of vinyl chloride.

2. The coating composition according to claim 1,
wherein the one or more fillers comprise mixtures of one or more silicatic fillers and one or more carbonatic fillers.

3. The coating composition according to claim 1, wherein the coating composition comprises 10% to 60% by weight of polymers, based on the dry weight of the coating composition.

4. The coating composition according to claim 1, wherein the coating composition comprises 20% to 55% by weight of polymers, based on the dry weight of the coating composition.

5. The coating composition according to claim 1, wherein the coating composition comprises 30% to 50% by weight of polymers, based on the dry weight of the coating composition.

6. The coating composition according to claim 1, wherein 0% to 20% by weight of the mineral binders are cementitious binders, based on the dry weight of the mineral binders.

7. The coating composition according to claim 1, wherein the one or more additives comprise one or more highly disperse silicas and/or one or more phyllosilicates.

8. Grouts, construction adhesives, jointing mortars, repair mortars or renders comprising the coating composition according to claim 1.

9. A permanently flexible coating produced from the coating composition according to claim 1.

10. The permanently flexible coating according to claim 9, wherein the permanently flexible coating has a coat thickness in a range from 1 to 10 mm.
